(19) United States
(12) Patent Application Publication
(10) Pub. No.: US 2024/0392483 A1
(43) Pub. Date: Nov. 28, 2024

(54) METHOD FOR NON-CONTACT HOMOGENEOUS MIXING OF FIBERS FEEDSTOCK FOR A CARDING PROCESS

(71) Applicant: University of Tennessee Research Foundation, Knoxville, TN (US)

(72) Inventors: Vinit Dilipbhai Chaudhary, Knoxville, TN (US); Uday Kumar Vaidya, Knoxville, TN (US); Pritesh Sudhakar Yeole, Knoxville, TN (US)

(73) Assignee: University of Tennessee Research Foundation, Knoxville, TN (US)

(21) Appl. No.: 18/652,194

(22) Filed: May 1, 2024

Related U.S. Application Data
(60) Provisional application No. 63/468,162, filed on May 22, 2023.

(51) Int. Cl. D04H 1/4382; B01F 23/50; B01F 23/60; D04H 1/4242; D04H 1/4291; D04H 1/44

(52) U.S. Cl. CPC D04H 1/43835; B01F 23/511; B01F 23/551; B01F 23/60; D04H 1/4242; D04H 1/4291; D04H 1/44; B01F 2215/044; B01F 2215/0454; B01F 2215/0477; D10B 2321/022; D10B 2401/063

(57) ABSTRACT

An improved method of preparing a carbon fiber-reinforced thermoplastic nonwoven web using recycled carbon fibers employs resonant acoustic mixing to combine the recycled carbon fibers with the thermoplastic fibers, followed by carding of the fiber mixture to form the carbon-fiber reinforced nonwoven web. The method provides a low-cost way to make carbon-fiber reinforced nonwoven webs that have sufficient mechanical properties to enable widespread use in the automotive industry and other high-volume industries.

### STATEMENT REGARDING FEDERALLY SPONSORED RESEARCH

This invention was made with government support under grant number DE-EE0006926, awarded by the United States Department of Energy. The government has certain rights in the invention.

### TECHNICAL FIELD

This application relates to the development and use of carded nonwoven webs formed from composites of recycled carbon fiber and polypropylene.

### BACKGROUND

The use of carbon fiber reinforced plastics (CFRPs) is rapidly growing in several industries such as aerospace, marine, automotive, and sports due to their outstanding mechanical properties. CFRPs have slowly replaced metals such as steel or aluminum in some areas due to the advantages of their high strength-to-weight ratio, lightweight, and durability. Carbon fibers (CFs) are used in these composites as reinforcement fibers which are defined by factors such as aspect ratio (length to diameter), orientation, fiber-matrix bonding, and processing conditions. CF composites can be made using either thermoplastics or thermosets based on the application. Yet more than 30% of the CF produced ends up as waste material in landfills at end of life (EOL) from sources such as decommissioned aircraft and industrial components. CF retains its properties over decades and potentially offers cost and other benefits if it can be recycled and repurposed.

Carbon fiber reinforced thermoplastic (CFRTP) composites are particularly in demand today. Polypropylene (PP) is a desirable thermoplastic because it is resistant to water, lightweight, and cost-effective. Because the CF composites are expensive, their applications have been mainly limited to aerospace industries high-end marine, automotive and sports, and have not included mass manufacturing industries such as mainstream automotive. The production of virgin carbon fibers (vCF) is a very energy-intensive process that requires 50-150 kWh/kg. Such a process with a high cost of precursor material results in a high price of CF composites.

### SUMMARY

The present disclosure is directed to carbon fiber reinforced thermoplastic (CFTRP) nonwoven webs made using recycled carbon fibers (rCFs) that are mixed with the thermoplastic fibbers using resonant acoustic mixing (RAM) to form a fiber mixture, whereupon the fiber mixture is then carded to form the rCFTRP nonwoven web. The rCFTRP nonwoven webs are useful in the automotive industry and other mainstream high-volume applications because of their low cost, good mechanical properties, and light weight. The relatively low cost results from the use of recycled carbon fibers (rCFs) instead of virgin carbon fibers (vCFs). The rCFTRP nonwoven webs are themselves recyclable, resulting in further economic and environmental advantages.

The rCFs can be prepared using any suitable recycling process. Suitable recycling processes include mechanical recycling, chemical recycling, and thermal recycling. In mechanical recycling, the carbon fiber reinforced plastic (CFRP) composites can be downsized by means of crushing, milling, or shredding. The resulting mixture can be further divided into fibrous fragments and powdered CFRP. The mechanical properties of the recovered fibers can be lowered because the length of the fibers is greatly reduced. Even after recycling, there is still some residual matrix material left behind in the rCFs. The thermoplastic matrix fibers can only be partially removed using an additional process called sieving.

Thermal recycling uses high temperatures to separate the matrix and reclaim the carbon fibers. This can be achieved by two techniques as (a) fluidized bed and (b) pyrolysis. Fluidized bed is a very common method of recycling CFRP to recover rCFs. The CFRP scrap is typically shredded to 6-20 mm before it enters the fluidized bed reactor. The shredded material is then fed into a bed of silica sand which uses hot air to separate the matrix and fibers at a temperature between 450° C. and 550° C., under a pressure of 10 to 25 kPa. Then the loose rCFs are separated from resin using a cyclone separator where the resin is completely oxidized. Typically, the reclaimed rCFs have a length in the range of 5-10 mm, preserving 10-75% of the tensile strength of vCF. This method's drawback is that the recovered rCF is in the form of tangled bundles, making it more challenging to align the fibers.

Using the pyrolysis method of thermal recycling, the CFRP waste is subjected to high heat (450° C. to 700° C.) in either air or an inert atmosphere to completely burn off the thermoplastic matrix fibers. When the matrix is burned in the presence of air, the immense heat generated can be captured for further processing or energy production. An inert atmosphere is desirable because CFs have a strong tendency to oxidize above 600° C., which can impact their mechanical properties. Furthermore, the sizing on the fiber surface can be reduced, which can detrimentally impact the fiber. One commercially available thermally recycled CF is available from ELG Carbon Fiber Ltd (UK) which was recently acquired by Gen 2 Carbon (UK). The company claims that its pyrolyzed rCF is 40% less expensive than vCF and keeps 90% of its tensile strength without loss of modulus.

In the chemical recycling process, also known as solvolysis, CFRP waste is depolymerized via an appropriate solvent to dissolve the matrix, leaving behind clean rCFs. The process parameters (pressure, temperature, and duration) and solvents (e.g., benzyl alcohol, glycol, catalytic solutions) vary on the type of plastic matrix material. The embodied energy used in the solvolysis process is much higher than in pyrolysis. In pyrolysis, an electric furnace using renewable energy and natural gas requires 3 MJ/kg and 41 MJ/kg respectively, whereas in solvolysis the deionized water and water/acetone mixture consume 257 MJ/kg and 278 MJ/kg respectively to separate the matrix and the fibers.

Factors to consider during recycling include fiber purity and sizing. The proportion of resin residuals left on the surface of the carbon fiber after recycling is referred to as fiber purity. In general, the rCF recovered via pyrolysis and solvolysis yields fibers of varying purity. When compared to pyrolysis, the solvolysis recycling method outputs higher fiber purity. The sizing of the recycled carbon fiber plays a key role for the composite functionality and can be selected to protect and improve interfacial adhesion between rCFs and the thermoplastic polymer fibers during consolidation.

The selection of thermoplastic polymer fibers also plays a key role in the functionality and performance of the rCFTRP nonwoven webs. The thermoplastic polymer fibers can be formed of polypropylene, including polypropylene homopolymers as well as copolymers of propylene with ethylene and/or other alpha-olefin comonomers. For most applications, the alpha-olefin comonomer content should be less that about 10% by weight and is suitably less than about 8% by weight, or less than about 6% by weight, or less than about 4% by weight, or less than about 2% by weight, or zero. Other thermoplastic polymers having sufficient strength, modulus and structural integrity can also be employed, including without limitation high density polyethylene, linear medium density polyethylene, linear low density polyethylene and, in some instances, branched low density polyethylene.

In accordance with the present disclosure, the rCFs and the thermoplastic fibers can be mixed together using resonant acoustic mixing (RAM). RAM uses low frequency energy to generate unique fiber movement and sound-induced acoustic interaction that can rapidly result in uniform mixing of the rCFs and the thermoplastic fibers. RAM can be used to mix dry bulk rCF and thermoplastic fibers, or fibers that are dispersed in a liquid. One suitable commercially available RAM mixer is the Resodyne Acoustic Mixer available from Resodyne Corporation of Butte, Montana. The fiber mixtures can include at least about 10% by weight rCFs or at least about 15% by weight rCFs or at least about 20% by weight rCFs or at least about 25% by weight rCFs, and can include up to about 50% by weight rCFs or up to about 45% by weight rCFs or up to about 40% by weight rCFs or up to about 35% by weight rCFs. The fiber mixtures can include up to about 90% by weight thermoplastic fibers or up to about 85% by weight thermoplastic fibers or up to about 80% by weight thermoplastic fibers or up to about 75% by weight thermoplastic fibers, and can include at least about 50% by weight thermoplastic fibers or at least about 55% by weight thermoplastic fibers or at least about 60% by weight thermoplastic fibers or at least about 65% by weight thermoplastic fibers. The resonant acoustic mixing can occur for about 30 seconds to about 10 minutes, or about 45 seconds to about 7 minutes, or about 1 minute to about 5 minutes, and can employ an acoustic mixing energy of about 25 grams force to about 200 grams force, or about 50 grams force to about 150 grams force, or about 75 grams force to about 100 grams force. The acoustic mixing force can be applied using a frequency of about 40 Hz to about 75 Hz, or about 50 Hz to about 70 Hz, or about 55 Hz to about 65 Hz.

The resulting fiber mixture can then be rinsed with water and dried (if needed) and can be carded to form the rCFTRP nonwoven web. Various carding devices can be employed, including without limitation a standard drum carder and a deluxe drum carder. A standard drum carder (referred to and described herein as carder 1) can include a small cylinder called a licker-in cylinder, a main cylinder called a swift cylinder, a polymer belt, copper bushings and a rotating handle. The fibers mixture is fed to a licker-in cylinder, which takes up the fibers and feeds them to the swift cylinder. The licker-in cylinder serves a dual purpose in creating a parallel stack of fibers on the swift cylinder. First, it brings the fibers into contact with the pins of the swift cylinder, and second, it retains the fibers as they roll onto the swift cylinder, allowing them to gradually align in the machine direction. The swift cylinder rotates faster than the licker-in cylinder and this difference in speed results in a uniformly aligned rCFTRP nonwoven web. The polymer belt exerts tension on the pulleys and transmits power from carder handle to rotate the cylinders. The polymer belt also absorbs unexpected shocks and blockages resulting from fiber clumps passing between rotating cylinders.

A deluxe carder (referred to and described herein as carder 2) is a right-hand coarse carder having a brush attachment that can be removed from the top of the frame and makes direct contact with the swift cylinder. The function of the attached brush is to keep the fibers intact while carding, which ultimately results in a uniformly aligned rCFTRP nonwoven web. The deluxe carder is otherwise similar to the standard carder except for different dimensions of some of the key parts.

With the foregoing in mind, it is a feature and advantage of the disclosure to provide a method of making a carbon fiber reinforced thermoplastic nonwoven web. The method includes the following steps:
providing a quantity of recycled carbon fibers;
providing a quantity of thermoplastic fibers;
mixing the recycled carbon fibers with the thermoplastic fibers using acoustic resonant mixing to provide a nonwoven fiber mixture; and
carding the nonwoven fiber mixture to yield the carbon fiber reinforced thermoplastic nonwoven web.

It is also a feature and advantage of the disclosure to provide a method of making a carbon fiber reinforced polypropylene nonwoven web that includes the following steps:
providing a quantity of recycled carbon fibers;
providing a quantity of polypropylene fibers;
mixing the recycled carbon fibers with the polypropylene fibers using acoustic resonant mixing to provide a nonwoven fiber mixture; and carding the nonwoven fiber mixture to yield the carbon fiber reinforced polypropylene nonwoven web.

It is also a feature and advantage of the disclosure to provide a carbon fiber reinforced thermoplastic nonwoven web having improved properties that can be made according to the foregoing methods. The foregoing and other features and advantages will become further apparent from the following detailed description, read in conjunction with the accompanying drawings.

### BRIEF DESCRIPTION OF THE DRAWINGS

FIG. 1 shows the global demand for carbon fiber (bar graph) and estimated waste carbon fiber (line graph).

FIG. 2 is a schematic drawing showing the resonant acoustic mixer (RAM) mixing mechanism illustrating formation of micro mixing zones during the mixing process.

FIG. 3 is a schematic drawing showing a carding process schematic. The fiber mixture is fed via feed rollers where the taker-in takes up the fibers and transfers them to the main cylinder. In the carding zone, the worker and stripper work simultaneously with the main cylinder for stripping and blending of fibers. In the doffer transfer zone, the fibers are stripped off from main cylinder via doffer cylinder resulting in a nonwoven carded web in the web formation zone.

FIG. 4 is a photograph showing as-received rCF from ELG Carbon Fiber Ltd. (Mean fiber length˜5 mm)

FIG. 5 is a photograph showing rCf and PP fibers in water before resonant acoustic mixing (for mixture no. 4, Table 3 in the Examples).

FIG. 6 is a photograph showing rCf and PP fibers in water after resonant acoustic mixing (for mixture no. 4, Table 3 in the Examples).

FIG. 7 is a photograph of a nonwoven rCF-PP carded web mat prepared using carder no. 2 according to the Examples.

FIG. 8 is a photograph showing a compression-molded rCF-PP unidirectionally carded panel (30% fiber weight fraction, panel thickness: 2.9 mm).

FIG. 9 (comparative) is a photograph showing a compression-molded rCF-PP isotropic wet-laid panel (30% fiber weight fraction, panel thickness: 2.8 mm).

FIG. 10 is a bar graph showing fiber length distribution (FLD) versus fiber count, using a tweezer method, for a nonwoven rCF-PP carded web prepared using RAM and carder 1.

FIG. 11 is a bar graph showing fiber length distribution (FLD) versus fiber count, using an ultrasonic method, for a nonwoven rCF-PP carded web prepared using RAM and carder 1.

FIG. 12 is a bar graph showing fiber length distribution (FLD) versus fiber count, using an ultrasonic method, for a nonwoven rCF-PP carded web prepared using RAM and carder 2.

FIGS. 13 and 14 are bar graphs showing flexural strength and flexural modulus, respectively, for nonwoven rCF-PP carded webs prepared using RAM and carder 1 from various rCF-PP mixtures described in the Examples. In FIG. 13, the flexural strength values reflect ranges of 5.91 MPa for Mix 1, 6.37 MPa for Mix 2, 4.32 MPa for Mix 3, 5.04 MPa for Mix 4, and 8.35 MPa for Mix 5. In FIG. 14, the flexural modulus values reflect ranges of 0.73 GPa for Mix 1, 0.63 GPa for Mix 2, 0.58 GPa for Mix 3, 0.22 GPa for Mix 4, and 0.42 GPa for Mix 5.

FIGS. 15 and 16 are bar graphs showing flexural strength and flexural modulus, respectively, for a nonwoven rCF-PP carded web prepared using RAM and carder 1, compared to an otherwise similar wet laid composite described in the Examples. The illustrated ranges extend equal distances above and below the top of each bar.

FIGS. 17 and 18 are bar graphs showing tensile strength and tensile modulus, respectively, for a nonwoven rCF-PP carded web prepared using RAM and carder 1, compared to an otherwise similar wet laid composite described in the Examples. The illustrated ranges extend equal distances above and below the top of each bar.

FIG. 19 is a bar graph showing ILSS strength for a nonwoven rCF-PP carded web prepared using RAM and carder 1, compared to an otherwise similar wet laid composite described in the Examples. The illustrated ranges extend equal distances above and below the top of each bar.

FIGS. 20 and 21 are bar graphs showing flexural strength and flexural modulus, respectively, for nonwoven rCF-PP carded webs prepared using RAM and carder 2, compared to an otherwise similar wet laid composite and a neat polypropylene as described in the Examples. The illustrated ranges extend equal distances above and below the top of each bar.

FIG. 22 is a line graph showing load versus displacement for nonwoven rCF-PP carded webs prepared using RAM and carder 2, compared to an otherwise similar wet laid composite and a neat polypropylene as described in the Examples.

FIGS. 23 and 24 are schematic illustrations of force transfer in an aligned nonwoven rCF-PP carded web composite versus a randomly oriented composite as described in the Examples.

FIGS. 25 and 26 are bar graphs showing tensile strength and tensile modulus, respectively, for nonwoven rCF-PP carded webs prepared using RAM and carder 2, compared to an otherwise similar wet laid composite and a neat polypropylene as described in the Examples. The illustrated ranges extend equal distances above and below the top of each bar.

FIG. 27 is an SEM image of a carded MD composite tensile test specimen showing fiber alignment.

FIG. 28 is an SEM image of a wet laid composite tensile test specimen showing random fiber orientation.

FIG. 29 is an SEM image of a carded MD composite tensile test specimen showing fiber pullout. The dotted line encircles examples of fiber pullout.

FIG. 30 is an SEM image of a wet laid composite tensile test specimen showing poor fiber/matrix adhesion. The arrow points to examples of poor fiber/matrix adhesion.

FIG. 31 is a bar graph showing ILSS strengths for nonwoven rCF-PP carded webs prepared using RAM and carder 2, compared to an otherwise similar wet laid composite described in the Examples. The illustrated ranges extend equal distances above and below the top of each bar.

FIGS. 32 and 33 are photographs of a carded MD ILSS test specimen and a wet laid ILSS test specimen, respectively.

FIG. 34 is a bar graph showing Izod break strengths for carded and wet laid rCF-PP composites and neat PP, for notched samples. The illustrated ranges extend equal distances above and below the top of each bar.

FIGS. 35 and 36 are photographs showing fractured Izod samples for carded and wet laid rCF-PP composites, respectively.

FIG. 37 is a line graph showing thermogravimetric analysis (TGA) results for neat PP and a rCF-PP composite.

FIG. 38 is a line graph showing DSC analysis for a rCF-PP composite using a heat-cool-heat cycle from room temperature to 220° C.

FIG. 39 is a line graph showing DSC analysis for neat PP using a heat-cool-heat cycle from room temperature to 220° C.

### DETAILED DESCRIPTION

The following detailed description will illustrate the general principles of the invention, examples of which are additionally illustrated in the accompanying drawings. In the drawings, like references indicate identical or functionally similar elements.

Except in the working examples, or where otherwise explicitly indicated, all numbers in this description indicating amounts, parts, percentages, ratios, and proportions of material, physical properties of material, and conditions of reaction are to be understood as modified by the word “about.” “About” as used herein means that a value is preferably +/−5% or more preferably +/−2%. Percentages for concentrations are typically % by wt. For pH values, “about” means+/−0.2.

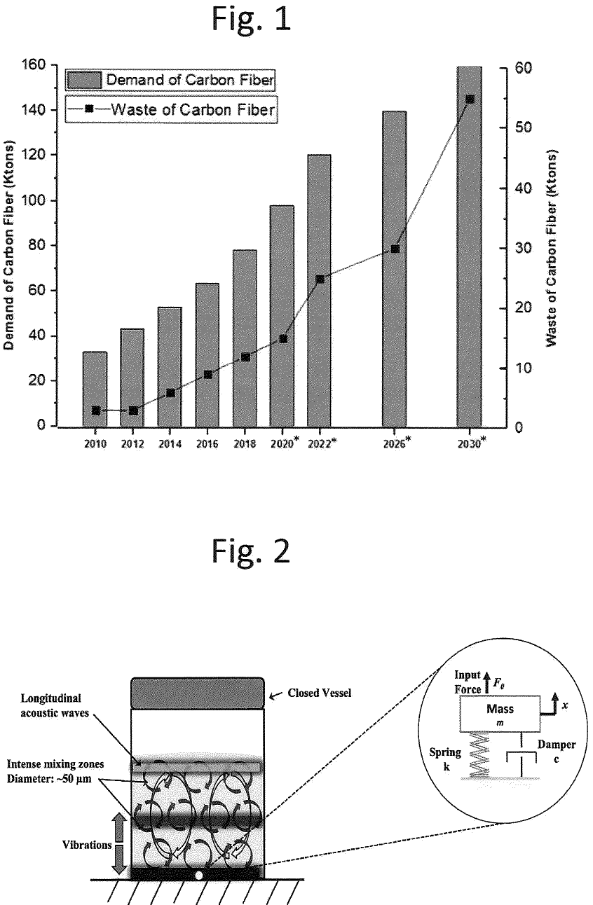

The inventors have discovered that two processing parameters, used in combination, enable the production of recycled carbon fiber-reinforced thermoplastic nonwoven webs (rCFRTP nonwoven webs) having improved mechanical properties that are suitable for mainstream, high volume applications in the automotive and other industries. These processing parameters are the use of resonant acoustic mixing (RAM) to achieve uninform mixtures of rcF and thermoplastic fibers, and the use of carding to achieve uniform alignment of the fibers in the rCFRTP nonwoven webs. By preparing rCFTRP nonwoven webs with the best possible mechanical properties, it becomes possible to find commercial uses for a large percentage of carbon fibers via recycling, which would otherwise require disposal. FIG. 1 shows the recent and expected growth of global demand for carbon fibers and estimates that, by 2030, about 60 kilotons per year of carbon fibers will either need to be recycled or disposed of.

FIG. 2 schematically illustrates the operation of a resonant acoustic mixer which can be used to mix the rCFs with the thermoplastic fibers to form a fiber mixture. A Resonant Acoustic® Mixing (RAM) is a unique ultra-fast mixing technique developed by Resodyne Corporation of Butte, Montana that works by applying a high-intensity acoustic field with a low resonant frequency (typically about 60 Hz) in a non-contact manner to facilitate the mixing. Referring to FIG. 2, in the RAM process, the fluid and a vessel can be explained as the mass-spring-damper system where energy is transmitted between the spring and the moving fluid mass. Unlike conventional mixing technology, where the mixing is focused at the tips of impeller blades, the RAM technology for acoustic mixing works on the principle of generating micro-mixing zones in the entire mixing vessel, which facilitates homogeneous mixing. RAM technology works with several different material types, including liquid-liquid, liquid-solid, gas-liquid, and solid-solid systems. RAM technology is designed in such a way that there is fundamentally no loss of the mixer system's mechanical energy into the materials being mixed created by the transmission of an acoustic pressure wave in the mixing vessel. The rCF's and the thermoplastic fibers can be mixed in the RAM either as dry fibers, or as fibers that are entrained and dispersed in water or another liquid as explained further below. If the fiber mixture is dispersed in a liquid, then most or all of the liquid should be removed before the fiber mixture enters the carding process.

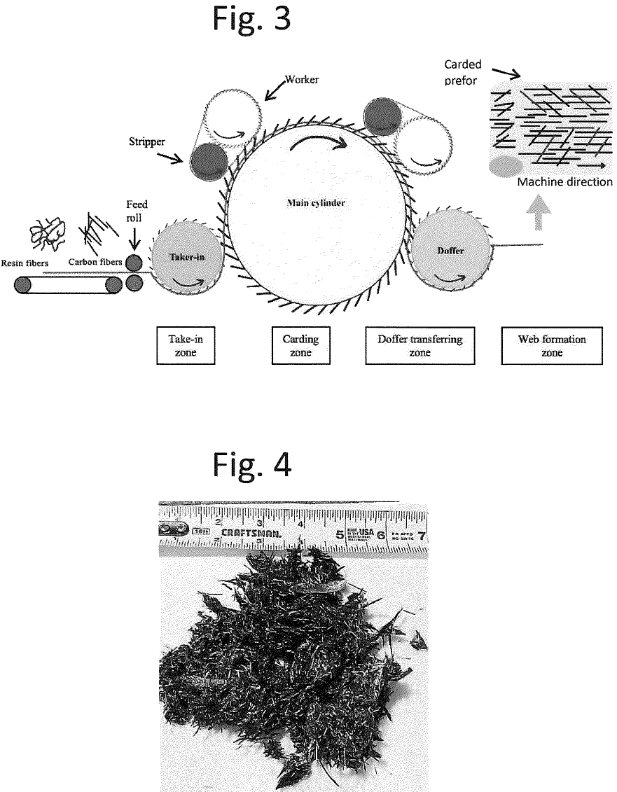

FIG. 3 schematically illustrates the operation of a carding process which can be used to align the fibers in the fiber mixture and produce the rCFRTP nonwoven web. Carding is a mechanical process aiming to disentangle the fiber stock into individual fibers to generate highly aligned nonwoven preforms with minimum fiber breakage. Carding works on a principle of fiber opening and layering actions carried out by toothed rollers present in the carding machine. Hence, carding opens fibers, removes waste, and blends the rCF and thermoplastic fibers thoroughly. Referring to FIG. 3, the core elements of a carding machine include a taker-in, sometimes referred to as a licker-in, the main cylinder, workers, strippers, and the doffer cylinder. Every standard roller carder has a main cylinder, often known as a swift, which is typically the largest cylinder. Around the main cylinder are smaller cylinders called workers and strippers, which typically function in pairs. The main cylinder is the most crucial part of the carding machine and is the central distributor of fibers throughout the carding operation.

The taker-in, also known as the licker-in, is the first cylinder where the fibers meet. In this zone, the fiber tufts are opened, and the pins on the revolving licker-in grab the fiber and transfer them to the main cylinder. Subsequently, the fibers are transferred onto the main cylinder in the carding zone where most of the processing occurs. In carding zone, the workers and strippers work simultaneously in contact with the main cylinder to achieve the necessary stripping and blending of the fibers. The continuous action of workers and strippers also avoids fiber overloading of the process. Finally, the fibers from the main cylinder are stripped off by the doffer cylinder in the doffer transferring zone, and the fiber exit the system in the form of a unidirectional nonwoven web preform. The remaining fibers spin around the cylinder's surface until they once again reach the doffer transfer zone, and this procedure is repeated until all fibers have transferred. The carded rCFRTP nonwoven can be bonded to improve the handling of the nonwoven web preform. The most common method to improve the handling of carded nonwoven mats is needle punching. Needles from a needle punching machine create a frictional interface between adjacent fibers, which results in the formation of a permanent bond among the fibers in the rCFRTP nonwoven web.

Carding quality is determined by several interrelated factors, including but not limited to fiber loadings on carding elements, fiber transfer rate, fiber mixing action, and fiber breakage. In the last 100 years, several efforts have been made to develop mathematical models and measurement systems to understand the parameters mentioned above for effective carding. One such vital parameter to consider is the fiber loading on carding cylinders. Several models have been created over the decades to help design modern fast carding machines. One model, developed by Krylov et al., examines how machine settings affect fiber loading on a flat-top card cylinder. See J. Meng, A. M. Seyam, and S. K. Batra, “Carding Dynamics Part I: Previous Studies of Fiber Distribution and Movement in Carding Fiber Movement and Distribution on Cards Distribution and Movement of Fibers on Carding el,” which is incorporated herein by reference.

Fiber transfer between cylinders is another important parameter to consider in carding. The main cylinder and doffer interaction are important in carding since doffer cylinder speed settings play an essential role in producing a uniform web structure. One model, developed by Baturin et al., considers how changing the machine's settings affect fiber transmission between the cylinder and doffer on a flat-top card. See J. Meng, “Study of Carding Dynamics,” 1996, which is incorporated herein by reference.

It is believed that the potential value of aligned rCFRTP is up to thirty percent more than that of randomly oriented rCFRTP due to the impact of fiber alignment on the modulus and strength of CFRTP nonwoven webs. On the contrary, the continuous action of carding teeth on the fibers can contribute to fiber breakage. Therefore, to successfully card rCF fibers on a carding machine, the machine parameters can be adjusted to minimize fiber attrition. One objective of recycling is to maintain the fiber length for as long as possible to allow for several recycling cycles. Additionally, longer CFs can significantly enhance the composite's mechanical properties. Therefore, the minimum fiber length should be around 30 mm before processing them in the carder since the fiber length is drastically reduced in the nonwoven manufacturing process. For example, the carbon fiber breakage can be minimized during the carding process by adding friction-reducing oil, increasing the distance between the cylinder and rollers, and varying the cylinder speed. Moreover, the number of worker-stripper pairings has been correlated with the degree of fiber orientation in the carded nonwoven webs. The RAM mixing procedure is employed herein to achieve a homogeneous rCF and thermoplastic fiber mass, which is important before processing the fibers in a carding machine. In the following Examples, carded and wet laid (WL) nonwoven web composites made of rCF (5 mm fiber length) and polypropylene (6 mm fiber length) are manufactured by compression molding so that the characteristics of the anisotropic carded nonwoven web composites can be compared with isotropic WL composites.

### EXAMPLES

The following non-limiting Examples are provided to demonstrate the effectiveness of the inventions described herein. For these Examples, the rCFs (Carbiso™ C IM56P) used in this work were provided by ELG Carbon Fiber Ltd. (U.K.) and were recovered via a modified pyrolysis process by ELG. According to the manufacturer, the rCF received was unsized since the sizing was entirely removed in the pyrolysis process. The reclaimed rCF used throughout this work were un-sized. The length of the rCF was between 3 and 10 mm, with a mean fiber length of 5 mm. FIG. 4 shows the rCF. Polypropylene fibers (PP) were chosen as the matrix fiber to be used with the rCF. MiniFibers Inc. (Johnson City, U.S.A.) manufactured and delivered the fibers in staple form (6 mm length, 1.65 dtex fineness). The detail of rCF and PP is summarized in Table 1 below.

TABLE 1
rCF and PP Material Specifications

| | | | | | Specific |
|---|---|---|---|---|---|
| | | | Tensile | Tensile | gravity |
| Material | Manufacturer | Code | Strength | Modulus | (g/cm³) |
| rCF | ELG | Carbiso ™ C | 4100 (MPa) | 259 (GPa) | 1.8 |
| | | IM56P | | | |
| PP | MiniFibers | PPSTD- | 2.5-3.8 | — | 0.90 |
| | | 070NRR | (cN/dtex) | | |

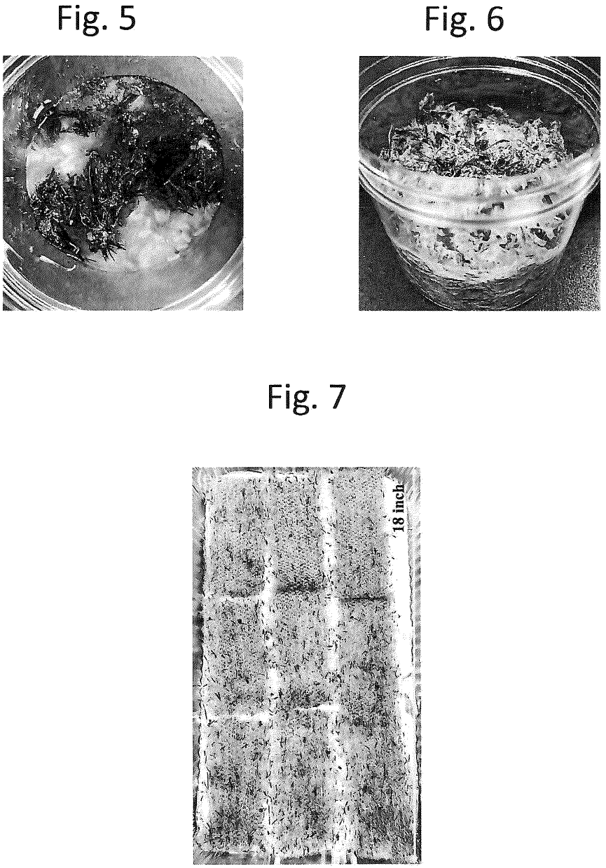

Fiber Mixing Technique. The resonant Acoustic Mixing (RAM) process (Resodyne Acoustic Mixers, Montana, USA) was used to mix rCF and PP fibers as dry bulk homogeneously and in two different liquid solvents. A scope test was performed using rCF fibers to determine the fibers mixing behavior and mixing parameters. Table 2 shows different mixes based on the overall fiber weight used in the vessel for a given mix. Five different types of mixing were performed, as shown in Table 3, to find the best mixing strategy to achieve a homogeneous rCF-PP mixture for the overall study. FIG. 5 and FIG. 6 show the homogeneous mixture of rCF-PP fibers before and after being processed in the LabRAM II system. The rCF and PP fibers were mixed at a 30:70 weight proportion for these Examples.

TABLE 2
rCF-PP Fibers Mixing Outline

| | Weight | | Mix 1 | Mix 2 | Mix 3 | Mix 4 | Mix 5 |
|---|---|---|---|---|---|---|---|
| Material | (%) | — | (gm) | (gm) | (gm) | (gm) | (gm) |
| Recycled | 30 | Scoping | 15.00 | 7.5 | 3.75 | 3.75 | 3.75 |
| Carbon Fiber | | Test | | | | | |
| Polypropylene | 70 | — | 35.06 | 17.50 | 8.75 | 8.75 | 8.75 |

TABLE 3
rCF-PP Mixing with Different Parameters Using LabRAM II

| | | | | Temp | Temp |
|---|---|---|---|---|---|
| | Polystyrene vessel | Time | Acceleration | before | after |
| Mixes | size | (min) | (g) | (° C.) | (° C.) |
| — | Scoping test (Only | 2 | 100 | 18.4 | 19.4 |
| | rCF) fibers 16 oz | | | | |
| Mix 1 | 32 oz | 1 | 75 | 18.4 | — |
| | | 2 | 100 | — | 20.1 |
| Mix 2 | 32 oz | 3 | 100 | 18.4 | 24.2 |
| Mix 3 | 32 oz | 5 | 100 | 18.4 | 22.7 |
| Mix 4 | 300 ml water 32 oz | 1 | 100 | 18.4 | 21.0 |
| Mix 5 | 300 ml isopropanol | 1 | 100 | 18.4 | 18.6 |
| | (IPA) 16 oz | | | | |

Carding Processes Used to Make rCF-PP Nonwoven Webs. The carding process can be divided into three stages: feeding, carding, and removing. Before processing the material in the carder, the rCF-PP fiber mixture was dried in the conventional oven for 6 hours at 80° C. to remove the moisture content. Two carding machines were used for these Examples, a standard drum carder (carder 1) and a deluxe baby drum carder (carder 2)

The Brother carder 1 is 12″ wide, 24″ long and 9″ tall, producing a 9″×22″ batt. It is a right-hand adjustable coarse carder with 72 TPI (teeth per inch), i.e., 72 pins on a carding cloth per square inch. The carder 1 machine consists of several parts such as a small cylinder called a licker-in drum, a main cylinder also known as swift, a poly belt, copper bushings and a rotating handle. The fibers mixture is fed to a licker-in cylinder. The function of licker-in drum is to take up the fibers and transfer them to the swift cylinder. The licker-in drum serves a dual purpose in creating a parallel stack of fibers on the swift cylinder. First, it brings the fibers into contact with the pins of the swift cylinder, and second, it retains the fibers as they roll onto the swift cylinder, allowing them to gradually align in the machine direction. The swift cylinder rotates faster than the licker-in cylinder and this difference in speed results in a uniform nonwoven mat. The poly belt's primary function is to exert tension on the pulleys and transmit power from carder handle to rotate the cylinders. Another essential function of a poly belt is to absorb unexpected shocks and blockages resulting from fiber clumps passing between rotating cylinders.

The design of carder 2 is similar, with few key differences. The carder 2 is 7″ wide, 20″ long, and 14″ tall and weighs around 14 pounds. It can produce 5″×22″ batts. It is also a right-hand coarse carder with 72 TPI. This carder has a brush attachment that can be removed from the top of the frame and makes direct contact with the swift cylinder. The function of the attached brush is to keep the fibers intact while carding, which ultimately results in a uniform nonwoven preform. The main difference in this carder is that the swift cylinder is 4″ wide, whereas in carder 1 it is 9.5″ wide. The diameter of the swift cylinder in both the carders is 7″. Another critical difference in both the carders is the pin length. Carder 1 has stainless steel pins of ½″, whereas carder 2 has ⅝″ long pins.

To accomplish the feeding step for each carder, the carding machine was positioned on a sturdy table with the help of a few clamps, so it would not displace when operational. Next, the dried rCF-PP mixture was fed slowly across the small drum by rotating the carder handle clockwise. To ensure that the fibers on the licker-in were dispersed uniformly, the fiber mixture was distributed equally over the carder feeding zone.

To accomplish the carding step for each carder, as the fibers were fed continuously, the small drum kept taking up the new fibers until it became full. During this process, the fibers were continuously sprayed with water using a mist spray bottle so that the rCF fibers did not fly out due to their short length when processed between the drums. After the small drum became fully saturated with fibers, the pins on the large cylinder started to pull fibers apart from the small drum. This was an important step in the production of the carded nonwoven webs. As the fibers were transferred onto the big drum, the unique arrangement of the metal pins on the carder acted to align fibers in machine direction. This process was continued until the big drum was covered up entirely by the fibers slightly below the metal pins.

To accomplish the removing step, once the big drum was full of fibers, a brush was used to separate the nonwoven web from the carder. The brush was held firmly against the pins, and the handle was slowly rotated in a counterclockwise direction. The brush lifted the nonwoven web slowly until the desired length was obtained. Finally, the nonwoven web was dried in an oven in an aluminum tray at 80° C. for 3 hours.

Before feeding the fibers into carder 1, both drums were covered by Peel Ply fabric. The Peel Ply was used only for carder 1 and facilitated removing the nonwoven mat at the end of carding operation. The rCF-PP nonwoven mat was obtained by first removing the peel ply fabric and then detaching the mat from the fabric. FIG. 7 is a photograph of a nonwoven rCF-PP carded web mat prepared using carder no. 2 according to the above-described process.

Preparation of Comparative rCF-PP Wet laid Nonwoven Mats. The isotropic rCF-PP WL nonwoven mats used for comparison were produced using an innovative mixing method in a hand sheet WL tank obtained from Adirondack Machine Corporation, of Hudson Falls, New York. The tank was a 12″×12″ stainless steel box that stores 30 liters of water. The top of the tank was equipped with a couple of stirrers that help mix fibers. The bottom of the tank had a removable stainless steel forming mesh to collect the final nonwoven mat.

The dried rCF-PP fibers, along with 2.0 g of dispersant (alkyl amine surfactant Nalco 8493™) and 2.0 g of viscosity enhancer (anionic flocculent Nalclear 7768™) were added to the water in the WL tank. The fibers were mixed for 10 minutes, and the water was drained through a fine mesh leaving behind a rCF-PP nonwoven mat (12″×12″). The prepared nonwoven mat was targeted to have a basis weight of around 280 g/m². The excess water was soaked out of the mat using a vacuum machine, and the mats were placed in a drier (Emerson Speed Dryer-Model 145) at 200 F for 20 minutes to dry. The mats were trimmed to 11″×11″ size for compression molding.

Compression Molding. Both the carded and WL rCF-PP nonwoven mats were prepared for compression molding to get a consolidated composite panel for further study. The rCF-PP nonwoven carded, and WL mats were fabricated into a consolidated flat composite panel via a heated compression molding Carver press (Model 3895). Due to the different sizes of the nonwoven mats, two different steel molds were used. A 6″×6″ mold was used to fabricate the carded nonwoven mats, whereas an 11″×11″ mold was used for the WL mats. The carded composite plates were fabricated by placing the mats in two arrangements: Unidirectional and 0°/90° cross-ply layup. The Carver press settings for both carded and WL compression molded panels are outlined in Table 4.

TABLE 4
Carver Press Parameters for rCF-PP

| | Pressure | Time | Temperature |
|---|---|---|---|
| | ton | minutes | (° C.) |
| Carding | 0.5 | 30 | 185 |
| | 1 | 3 | |
| | 1.4 | 3 | |
| | 1.8 | 30 | |
| WL | 1.7 | 30 | |
| | 3 | 3 | |
| | 5 | 3 | |
| | 6.5 | 15 | |

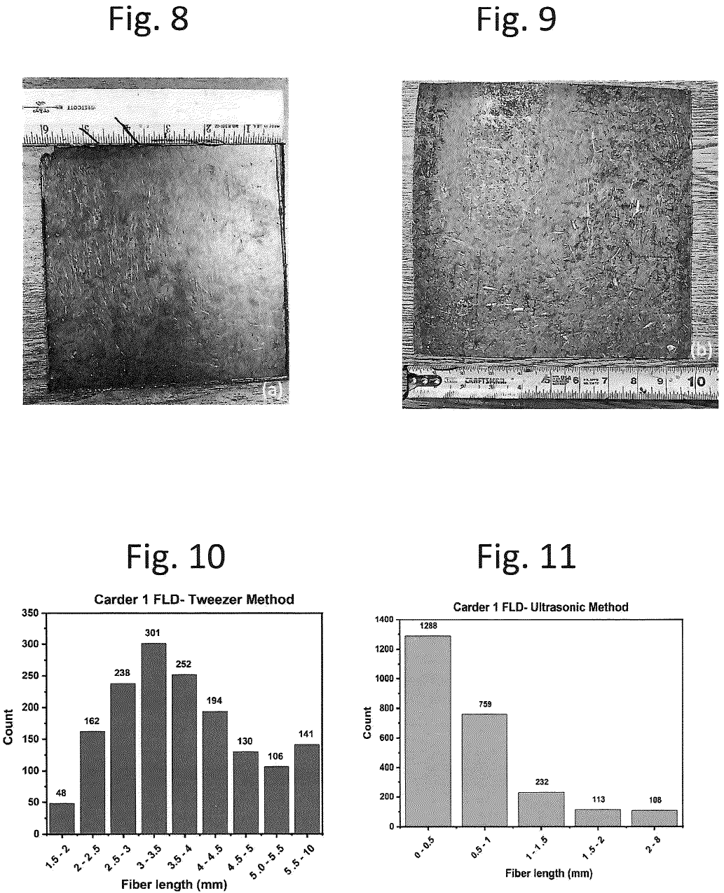

Polypropylene has a low melting point, at around 160° C. This information, along with differential scanning calorimetry (DSC) and thermogravimetric analysis (TGA) results, was used to establish the processing conditions to get well consolidated rCF-PP panels as shown in FIG. 8 for the compression molded unidirectional carded rCF-PP panel (30% fiber weight fraction, panel thickness: 2.9 mm) and FIG. 9 for the comparative isotropic wet laid rCF-PP panel (30% fiber weight fraction, panel thickness: 2.8 mm). A total of 14 layers of carded nonwoven mats were layered in the mold, whereas for WL, a total of 9 layers were stacked to achieve a 3 mm thick plate. Similarly, a neat PP plate was made using similar processing parameters as carding composite plate.

### Fiber Length Distribution (FLD)

A burn off test was conducted on the rCF-PP carded nonwoven mats to remove the PP polymer and recover the carded rCF fibers, thereby evaluating the relation between fiber breakage and mechanical properties following carding. The effect of pin length on fiber breakage was investigated using mats made with both carders. A carded rCF-PP mat wrapped in aluminum foil was placed in an aluminum tray inside a box furnace (Thermo Fisher Scientific, Model #BF51728C-1, Waltham, MA), at 400° C. for 4 hours. The rCF were left behind in a clumped fiber bundles after the PP matrix fibers were completely burned off. The rCF fiber bundles must be separated into single fiber filaments to measure the effective length. For the FLD study, two methods were used to separate fiber bundles: 1) the tweezer method and 2) the ultrasonic method. In the tweezer method, the fiber bundles were separated physically with a plastic tweezer and collected on a white piece of paper, and scanned under a scanner (Canon Canoscan LiDE 400, 4800 dpi) to record the image. At least 1500 single fiber filaments were measured manually in Image J software (version 1.53a, bundled with Java 1.8.0_172). In the ultrasonic method, the rCF fiber bundles were put into a glass vial with an acetone solution. The glass vial was submerged into an ultrasonic bath (Fisher Scientific, Waltham, MA) for a few seconds until fiber bundles were separated into fine individual fibers. Then the solution was immediately pipetted out and poured on a microscopic slide (2 in.×2 in.), so the acetone could evaporate. After the evaporation of acetone, the fibers were imaged using a VHX-5000 digital microscope (KEYENCE Corporation, Itasca, IL). Then the fibers were measured using a python script in Image J software. At least 1500 fibers were measured for each sample and method type.

Since fiber length is preserved in the WL process, the fiber length distribution (FLD) was performed only on carded, nonwoven mats. First, the FLD study was performed on carder 1 with a pin length of ½″ using both the tweezer and ultrasonic methods (FIGS. 10 and 11). The FLD analysis using the tweezer method showed that 301 fibers out of 1572 fell in the range of 3-3.5 mm, i.e., 19% of the fibers were in this range after carding. The FLD analysis using ultrasonic methods showed that 1288 fibers out of 2500 fell in the range of 0-0.5 mm, i.e., 51.5% of the fibers were in this range after carding. The mean fiber length Iₘ after carding using the tweezer method was 3.77 mm, compared with 0.68 mm using the ultrasonic method. Compared with the starting rCF length of about 5 mm, the carding reduced the Iₘ by 24.6% using the tweezer method and by 86.4% using the ultrasonic method.

After the burn-off test, the rCFs obtained were mainly in the form of bundles. In the tweezer method, one tweezer was used to hold the bundles, while the other tweezer was used to shake the bundles to separate the fibers for the FLD study. Because this process is done by hand and CFs are chosen by hand in a subjective way, as well as the brittle nature of carbon fibers under applied load, this process is susceptible to mistakes. Therefore, the FLD study on carder 2 was carried out with only the ultrasonic method.

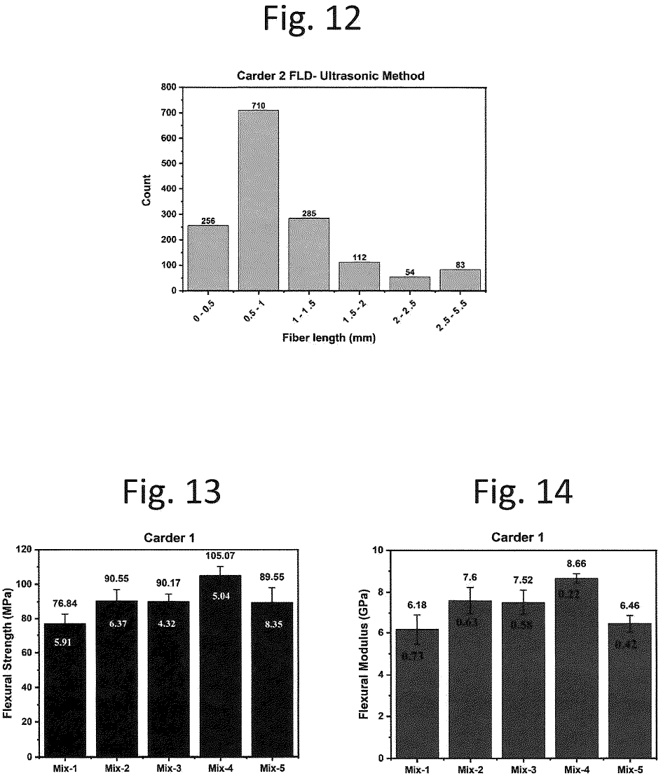

FIG. 12 shows the FLD analysis via an ultrasonic method on rCF-PP nonwoven mats manufactured on carder 2 with a pin length of ⅝″. Around 1500 fibers were measured. The FLD data shows that 710 fibers fell in the range of 0.5-1.00 mm, meaning 47.3% of the fibers were in range of 0.5-1.00 mm after carding. The lₘ after carding using the ultrasonic method was 1.03 mm. Hence, it was observed that there was a 79.4% reduction in the lₘ of the rCFs after carding on carder 2.

For discontinuous fibers, the critical fiber length (l_{c}) is one important criterion to understand the load transfer mechanism in the composite. The l_{c} is the minimum fiber length that must be present to transmit a significant amount of load from the matrix to the fiber before the occurrence of fiber fracture. The following equation can be used to calculate the critical fiber length.

$${l}_{c} = \frac{{σ}_{fu} {a}_{f}}{2 {τ}_{i}}$$

where σ_{fu} is fiber ultimate tensile strength, d_{f} is fiber diameter and τᵢ is the shear strength of the fiber-matrix interface. Based on the Tresca yield criterion, the value of τᵢ can be approximated by assuming that the shear strength of the fiber-matrix interface is the same as the matrix shear strength, using the following equation.

$${τ}_{i} = \frac{{σ}_{m}}{2}$$

where σₘ is matrix ultimate tensile strength. The value of σₘ for PP fibers is 23.05 MPa which is obtained via tensile testing as seen in subsequent paragraphs. Therefore, using the first above equation, the approximate l_{c} value is 0.89 mm. The fiber and matrix mechanical properties required to calculate l_{c} are summarized in Table 5. From above, the lₘ value for carder 1 is 0.68 mm, whereas for carder 2 the lₘ value is 1.03 mm. In carder 1 the lₘ<l_{c}, implies that the maximum fiber stress will never reach the maximum fiber strength. In this scenario, the matrix or the fiber-matrix interfacial connection may fail before the fibers reach their ultimate strength. On the contrary, in carder 2 the lₘ>l_{c}, which shows that over a large portion of fiber length, the maximum fiber stress may equal the ultimate fiber strength. Hence for further characterization data, carder 2 was used.

TABLE 5
Characteristics of Composite Components

| Property | Value | Unit |
|---|---|---|
| rCF ultimate tensile strength, σσ_{fu} | 4100^{a} | MPa |
| rCF tensile modulus, E_{f} | 259^{a} | GPa |
| Mean fiber length after carding, lₘ | 1.03 | mm |
| Critical fiber length, l_{c} | 0.89 | mm |
| rCF fiber diameter, dd_{f} | 5 | μm |
| Ultimate PP tensile strength, σσₘ | 23.05 | MPa |
| PP matrix tensile modulus, Eₘ | 1.24 | GPa |
| Interfacial shear strength, ττᵢ | 11.5 | MPa |

FLD data demonstrates that both carders significantly reduced the lₘ of the rCFs. This is due to the absence of sizing and fiber degradation in the pyrolysis process. Due to the absence of sizing, the rCFs experienced higher friction and stress during carding, which affected the lₘ of the fibers. In addition, following the carding process, the nonwoven mat underwent pyrolysis so that the matrix could be removed and the rCFs could be obtained for FLD analysis. In this process, the rCFs may have degraded further, increasing the likelihood of fiber breakage.

### Fiber Mixing Experiments

To establish a method that deagglomerated and homogeneously mixed the fibers, five different mixing tests were carried out, as shown in Table 3, above. The results of those mixtures are summarized in Table 6. Compared to mix tests 1-3, mix tests 4 and 5 showed promising results where the rCF and PP fiber mixtures appeared to have been deagglomerated and homogeneously mixed. The mix test 1-3 were dry mixes, and the results showed that the rCF-PP mixtures kept expanding in the container, and eventually stopped mixing, resulting in incomplete fiber mixtures. To tackle this issue, water and IPA was introduced as a mixing solvent in mix test 4 and 5, respectively. The results showed that water and IPA solvents prevented the fiber mixtures from expanding within the container and aided in achieving homogeneous rCF-PP fiber mixtures.

TABLE 6
Results of Premixing of rCF-PP Using RAM Technique

| | Polystyrene | |
|---|---|---|
| Mixes | vessel size | Observations |
| | Scoping test | Increase in volume as time went on |
| | (rCF) 16 oz | |
| Mix 1 | 32 oz | 1) Fill was extremely high |
| | | 2) The mixture expanded further as |
| | | mix continued |
| Mix 2 | 32 oz | Less fibers fill height but still expanded |
| | | in container |
| Mix 3 | 32 oz | Time was increased and the fill was decreased. |
| | | Fiber's agglomerations still visible |
| Mix 4 | 300 ml water | The addition of water aided in mixing and fibers |
| | 32 oz | appeared to deagglomerate and homogeneously |
| | | mixed |
| Mix 5 | 300 ml IPA | The addition of IPA aided in mixing and fibers |
| | 16 oz | appeared to deagglomerate and homogeneously |
| | | mixed |

Fibers from the five different mixes were fed to a carder 1 to produce five different rCF-PP nonwoven mats. The mats were consolidated into compression molded panels and were tested for mechanical properties as discussed below.

Mechanical Characterization of the rCFRTP Nonwoven Webs

As mentioned in previously, carding is a dry-laying mechanical process disentangles the fibers into individual fibers to generate highly aligned nonwoven preforms. On the contrary, WL is a wet laying process that produces randomly aligned (isotropic) nonwoven preforms. The two methods are compared based on their mechanical properties and the variables affecting those properties.

### Flexural Testing, Tensile Testing, and Interlaminate Shear Strength (ISS).

The flexural properties for the specimens were measured per ASTM D790 standard, using a Test Resource frame (Model #: 313, MN, USA) with a 50-kN load cell. Five coupons were prepared from a compression molded rCF-PP panel of each type. The flexural specimens (75×15×3.75 mm³) were loaded at 1.6 mm min⁻¹ with a span length of 60 mm. Initially, the fibers from mixes 1-5 were fed into a carder 1 to produce five different rCF-PP nonwoven mats. The mats were molded into panels and were tested for flexural properties. The flexural strength and modulus for rCF-PP nonwoven panels produces from mixtures 1-5 can be seen in FIGS. 13 and 14.

Tensile tests were conducted as per ASTM D638-Type 1 standard to investigate the degree of fiber alignment on carded specimens compared to isotropic wet laid specimens. The test was performed on a Test Resource frame (Model #: 313, MN, USA) with a 50 kN load cell and a constant crosshead speed of 2 mm/min. The strain data was calculated using an extensometer (Model: 3542, Epsilon Technology Corp, WY, USA) with a gauge length of 25.4 mm. Five dog bone samples from each panel type were prepared with a gauge length of 50 mm.

The interlaminar shear strengths of rCF-PP composite samples were measured per ASTM D2344 standard using a Test Resource frame (Model #: 313, MN, USA) with a 50-kN load cell. Similarly, to the flexural test, five coupons were prepared from a compression molded rCF-PP panel. The ILSS specimens (22×7.5×3.75 mm³) were loaded at 1.0 mm min⁻¹ with a span length of 15 mm.

The results showed that the flexural strength and modulus of the rCF-PP composite panel from mix test 4 showed higher properties than other mixes. This outcome can be attributed to the water used in mix test 4, where the fibers seemed completely deagglomerated and well-mixed. Also, mix test 5 showed a homogeneous fiber mixture with IPA as a mixing solvent. In addition, the rCF-PP composite panels from mix tests 1-3 and 5 showed similar flexural properties. Hence, the results from RAM mixing test and flexural properties, mix test 4 was selected as the suitable mixing strategy for future study. This decision was made since water would be a more economical mixing solvent than IPA.

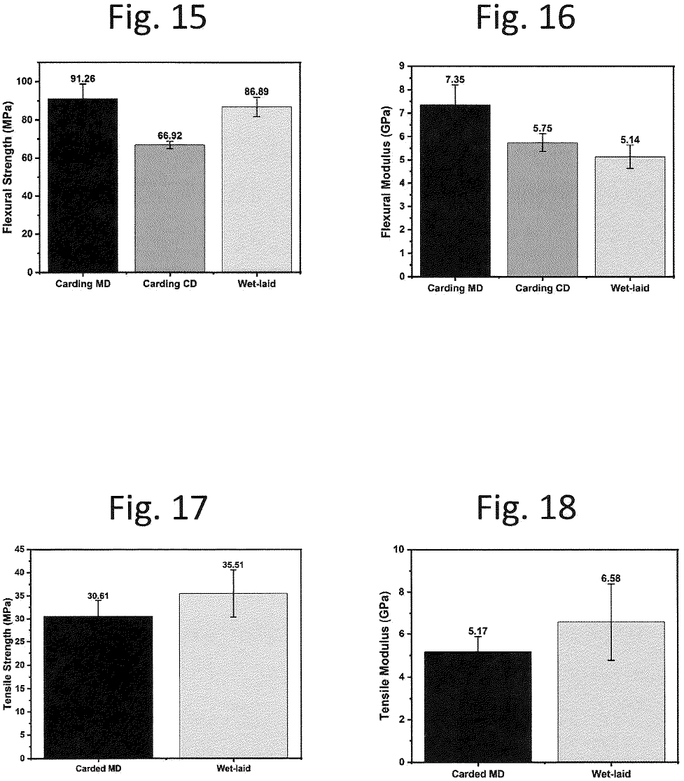

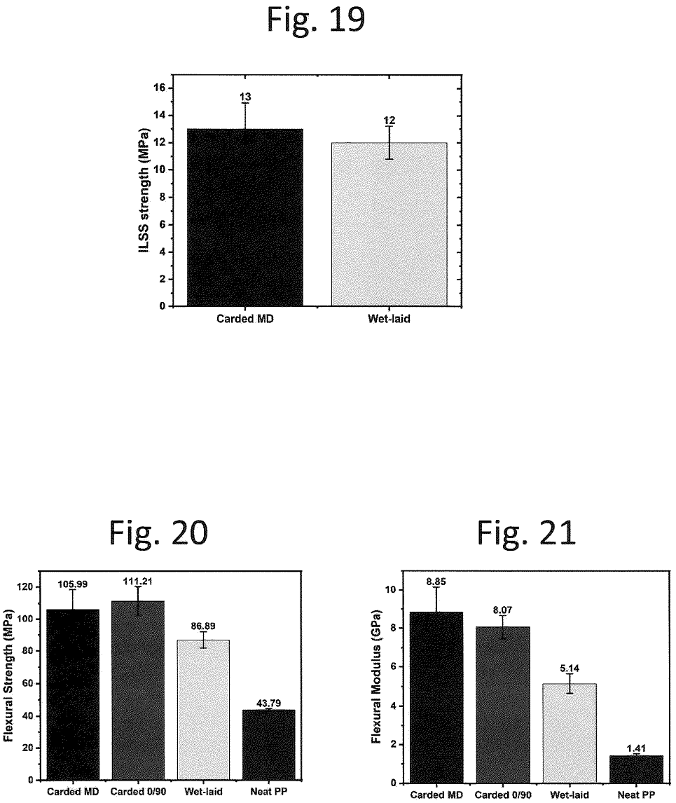

In next phase of this study, the rCF-PP mixture was mixed using RAM with water as a mixing solvent as in mix test 4. Further, the rCF-PP nonwoven preforms were fabricated using carder 1 and the wet laying (WL) process. The flexural coupons were extracted from the carded panel in the machine direction (MD) and cross-direction (CD). Also, five flexural coupons were extracted from the wet laid panel. The flexural properties of carded MD, CD, and wet laid panels are illustrated in FIGS. 15 and 16. Thereafter, tensile and ILSS specimens were extracted from carded and wet laid panels. The tensile and ILSS properties of carded and wet laid rCF-PP composites are shown in FIGS. 17, 18 and 19.

The flexural results show that the carded MD composite panel had higher flexural strength and modulus than the carded CD composite by 36.4% and 27.8%, respectively. Moreover, the flexural strength and modulus of carded MD composite panel were 5% and 43% higher than those of the wet laid panel. The flexural results suggest that carded MD composites exhibit anisotropy when compared to carded CD, while carded MD and wet laid composites have nearly identical flexural strength.

The tensile data shows that the wet laid composite has higher tensile strength and modulus than carded MD by 16% and 27.3%. It is possible that the lower tensile strength in the carded MD composite can be attributed to significant fiber breakage that occurred during carding, resulting in a shorter lₘ value of rCFs post-carding. In contrast, the fiber length was preserved in the wet laid composite, resulting in a longer fiber length than the critical fiber length.

The ILSS test was run on samples of carded MD and wet laid composite, with carded MD achieving 13 MPa ILSS strength and the wet laid composite achieving 12 MPa ILSS strength. The ILSS results show no discernible variation in the properties, and the results comply with the flexural characteristics. It is believed that fiber length significantly improves polymer composites' mechanical (flexural, tensile, and impact) strength and stiffness. Therefore, l_{c} plays a crucial role in understanding the mechanical properties of discontinuous fiber-reinforced polymer composites. After carding, the calculated l_{c} value of rCF was 0.89 mm. From the FLD study the lₘ value for rCF after carding on carder 1 was 0.68 mm. The lₘ of rCF is clearly lower than critical fiber length (lₘ<l_{c}). As explained in the FLD section, the fibers may never reach maximum fiber stress, leading to matrix or fiber-matrix interface failure before the fiber reaches its ultimate strength. In addition, handling rCF-PP nonwoven webs manufactured on carder 1 was quite tricky. After considering all the difficulties and drawbacks associated with the basic drum carder, it was decided to upgrade the carder to a carder 2 for further study.

A similar procedure as carder 1 was repeated on carder 2 to manufacture rCF-PP nonwoven web composites. A burn-off test was performed to recover the rCFs for the FLD study. The results from FLD analysis shows that the lₘ value of the rCFs was around 1.03 mm. In this scenario, lₘ>l_{c}. In this case, the fiber may transfer the stress until it reaches ultimate fiber strength over a significant portion of its length. Hence, various mechanical characterization was performed on rCF-PP panels to compare the carding and wet laying techniques. Based on TGA analysis it was observed that the carded composite showed 27% fiber weight fraction. Also, TGA analysis was not conducted on the wet laid composite samples as literature suggests no fiber loss during manufacturing. Further, a neat PP panel was fabricated via compression molding and tested to understand the effect of rCF reinforced polymer.

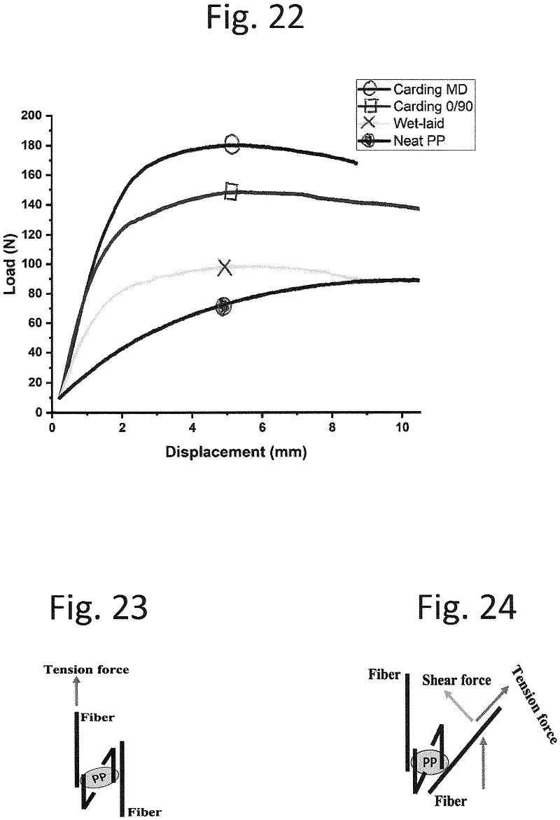

The mechanical properties of the rCF-PP composite (carder-2, WL) and neat PP are summarized in Table 7. The flexural properties of the carded and wet laid composites, along with neat PP, are illustrated in FIGS. 20 and 21. The flexural strengths of carded MD and carded 0/90 were within 5% of one another. Compared to the wet laid composite, the flexural strength of the carded MD composite was 22% higher. Similar trends in flexural strength and modulus were observed. Carded MD and 0/90 composite flexural moduli were within 10% of each other, but when compared to the wet laid composite, the carded MD flexural modulus was 72.2% higher. Overall, the carded MD composite flexural properties were higher than the wet laid composite. The result can be attributed to carded and wet laid mat thickness variation. The wet laid mats were well-packed and thinner (˜3 mm) compared to carded mats, which were fluffy and thicker (˜9.5 mm). Based on the flexural properties, it can be assumed that carded mats were aligned in MD. Due to carded mats being thicker, the fibers may be oriented differently in various planes, but overall, the fibers will be aligned in MD along the mat thickness. In this way, carded nonwoven mats offer more rigidity while molding than the wet laid mats, which may explain why the former has superior flexural properties. In addition, the load vs. displacement curves of the aforementioned flexural samples is shown in FIG. 22. The slope of the load vs. displacement plot shows the variation in fiber modulus between the carded MD, 0/90, wet laid, and neat PP samples. The plot clearly shows linear deformation due to ductile failure with a significant difference in elongation behavior between the carded and wet laid samples. In contrast to the significant strain experienced by the fibers in a wet laid flexural composite, the results show that fibers in the carded MD composite successfully transferred stress without significant strain owing to fiber alignment in the machine direction (MD).

TABLE 7
Mechanical Properties of Carder-2, WL, and Neat PP samples.

| Mechanical Testing | | | Carding MD | Carding 0/90 | WL | Neat PP |
|---|---|---|---|---|---|---|
| Flexural | Strength | Mean | 105.99 | 111.21 | 86.89 | 43.79 |
| | (MPa) | STD | 12.42 | 8.91 | 5.1 | 0.67 |
| | Modulus | Mean | 8.85 | 8.07 | 5.14 | 1.41 |
| | (GPa) | STD | 1.3 | 0.61 | 0.5 | 0.10 |
| | Strength | Mean | 62.10 | 57.20 | 35.51 | 23.05 |
| | (MPa) | STD | 4.8 | 1.9 | 5.1 | 1.27 |
| Tensile | Modulus | Mean | 13.87 | 9.20 | 6.58 | 1.24 |
| | (GPa) | STD | 1.57 | 2.00 | 1.81 | 0.10 |
| ILSS | Strength | Mean | 15.00 | 14.00 | 12.00 | — |
| | (MPa) | STD | 0.65 | 1.16 | 1.2 | — |
| Izod | Impact | Mean | 46.30 | — | 33.66 | 3.18 |
| | energy | | | | | |
| | (KJ/m²) | STD | 5.88 | — | 8.05 | 0.28 |

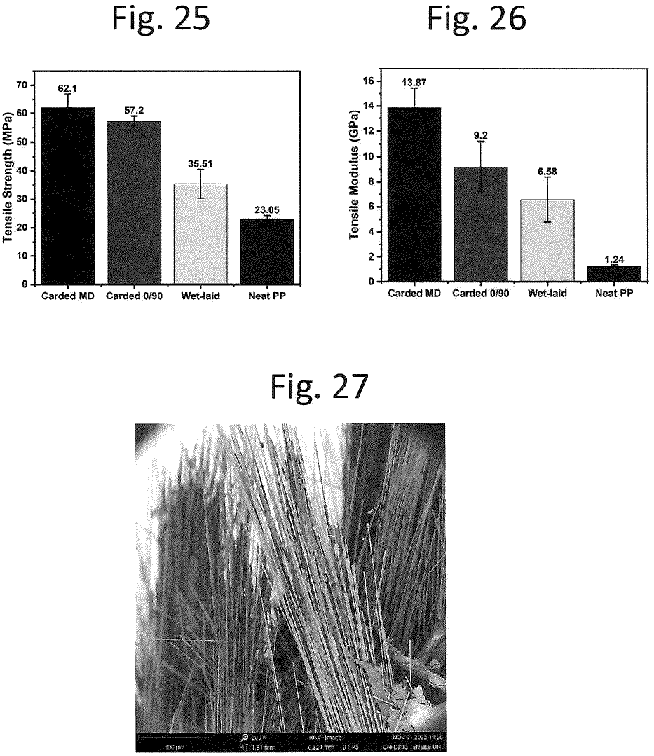

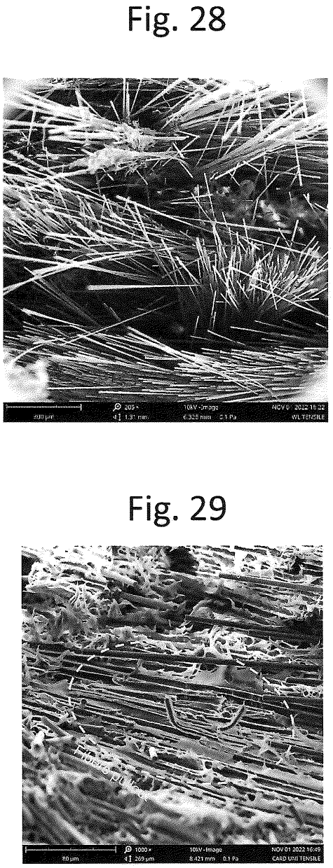

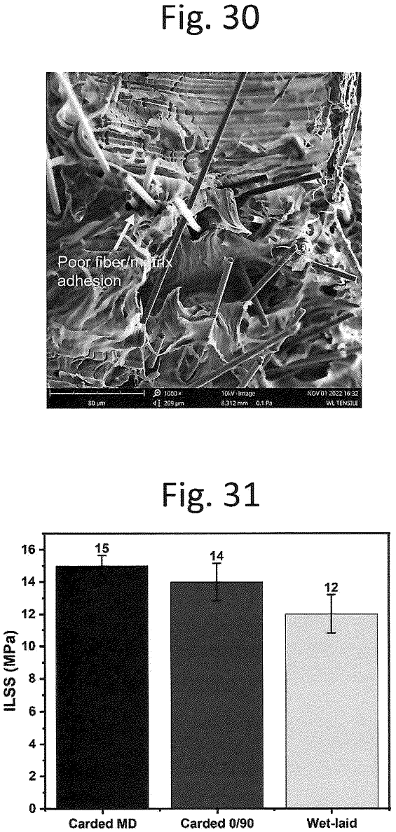

The tensile test was also performed on the carded and wet laid composite samples. The tensile properties showed similar trend as flexural properties. The nature of the carding process caused the rCF fibers to be oriented in a direction parallel to the carding direction (MD), while the nature of the wet laying process caused the rCF fibers to be orientated in a random pattern. This phenomenon can be further explained by comparing both processes' tensile properties (FIGS. 25 and 26). As seen in Table 7, carding MD and 0/90 tensile strengths were within 10% of each other. When compared to the wet laid composite (35.51 MPa), the carding MD composite tensile strength (62.10 MPa) was 75% higher. In addition, the tensile modulus of the carded MD composite was much greater than those of carded 0/90 and wet laid composites by 50.8% and 110.8%, respectively. Overall, the carded composite showed significant tensile properties over the wet laid composite, which can be attributed to the fiber alignment achieved during the carding process. The results of the SEM analysis of fractured tensile composite specimens validates this assumption; see FIGS. 27 and 28. In the carded MD composite test specimen, most rCFs are parallel and aligned with the carding MD, whereas, in the wet laid composite test specimen, the fibers show random orientation. Also, as seen in the wet laid test specimen SEM image, there were not many fibers in longitudinal direction contributing to the tensile load, which accounts for the significant gap between tensile properties of the carded and wet laid composite samples. This highlights the significance of the fiber alignment produced by the carding process. However, SEM analysis of the fractured surface (FIG. 29) of the carding composite samples indicated that failure occurred predominantly via fiber pull-out from the PP matrix, showing poor fiber/matrix interfacial bonding. In the wet laid composite (FIG. 30) fiber pull out was not apparent due to random fiber orientation but weak fiber/matrix bonding was apparent.

This might be because of non-polar chemical bonds on the surface of the PP matrix, which prevents them from bonding with the rCF's smooth surface. Further, the vast difference in carding and WL tensile properties can be briefly explained by two cases. Case 1: FIG. 23 shows that when the fibers are parallel (aligned), most of the force applied to carp is transferred to the fibers, that are stronger than PP. Case 2: On the contrary, FIG. 24 shows that when fibers are not parallel (randomly oriented), a portion of the applied force is transferred to the PP as a shear force, leading to the early failure of the rCFRP compared to case 1. Thus, case 1 may be seen in carded composites and case 2 in wet laid composites. Furthermore, Ashby plots for rCF composites show that with the increase of tensile modulus, tensile strength also increases. Most wet laid composites have low modulus and strength, but carded composites have greater strength at the same stiffness. The difference in properties can be attributed to two critical factors: fiber dispersion and fiber alignment. Generally, highly aligned webs have the best fiber alignment, followed by carding, air-laid, and wet laid nonwoven webs. In addition, the fiber dispersion in wet laid nonwoven webs is often poor due to the absence of a fiber opening stage, as there is in carding. Also, in carding process, premixing rCF-PP using the RAM technique enables greater fiber dispersion during carding, leading to well-dispersed aligned rCF-PP nonwoven webs as opposed to poorly dispersed randomly oriented WL webs.

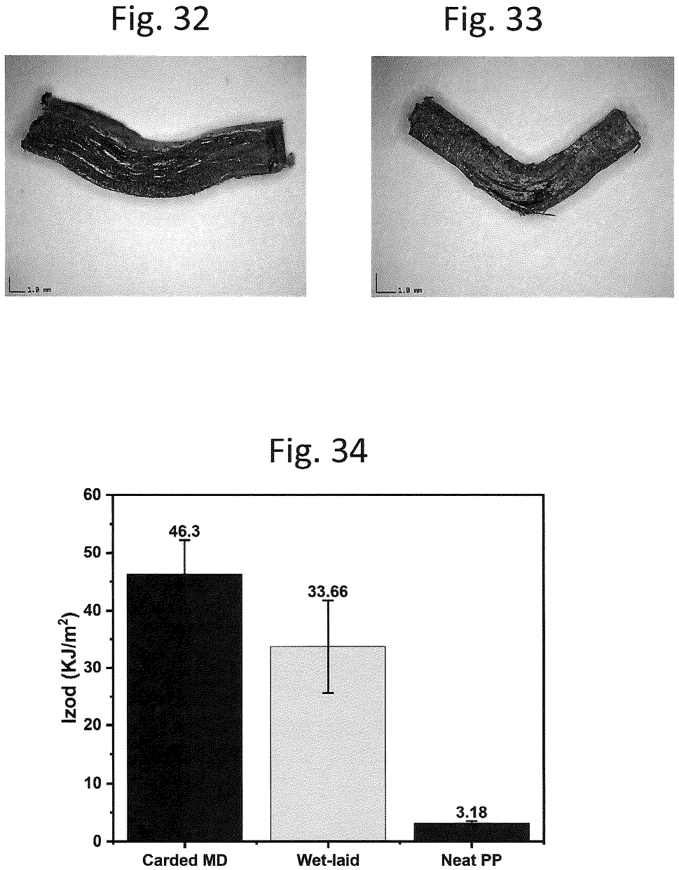

The ILSS test was performed on Carded MD, 0/90, and wet laid composite samples to compare the shear strength between the composites plane of lamination. In general, the ILSS properties of carded composites were slightly higher than for the wet laid composites. The results show that the ILSS strength of the carded MD and 0/90 composites were within 7% of each other, whereas the ILSS strength of the carded MD composite was 25% higher compared to the wet laid composite (FIG. 31). As stated previously, the carded rCF-PP nonwoven mats were thicker than the wet laid mats. Consequently, carded mats would have some out-of-plane fiber orientation due to carded pins during carding, which would promote the interlaminar bonding between layers. Hence, the carded composite mat ILSS properties were higher than for the wet laid composite mats. The optical images of tested ILSS specimens validate this assumption. FIG. 32 shows the ILSS tested carded MD composite specimen which did not show any surface failure. Yet the ILSS tested WL composite specimen showed interlaminar shear failure in tension, as shown in FIG. 33.

Izod Impact Testing. A Tinius Olsen IT 504, with a 22.6 J loading capacity and a 37 N pendulum weight, was used to conduct the Izod impact test per ASTM D-256 in order to understand the amount of stress a material can absorb before it breaks. Five specimens from each panel were extracted, measuring 64 mm×12.7 mm. Specimens were made using a notch type A with a radius of 0.25 mm and a notch angle of 45°. The notch on the Izod samples were machined on HAAS (VM-3) with a custom 3D printed Izod specimen holder.

The Izod test was performed on carded MD and wet laid rCF-PP composites to examine how fiber alignment impacts the composites' ability to absorb and distribute energy under impact loading in isotropic and anisotropic composites. The results show that the carded MD composite had an impact energy of 46.30 KJ/m² whereas the WL composite had an impact energy of 33.66 KJ/m², i.e., the carded MD composite samples could absorb 37.55% more impact energy than the wet laid composite samples. The results were compared to the neat PP Izod-tested samples (FIG. 34). Two failure modes were observed for carded MD specimens: hinged and complete break. Six of the carded MD specimens failed as hinged while one of them failed completely.

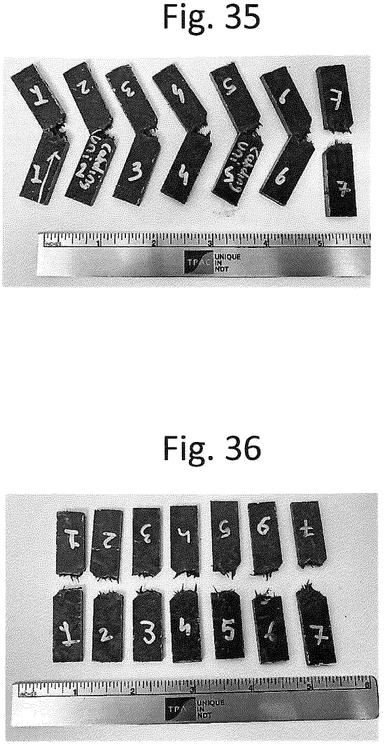

In contrast, the failure mode on the wet laid Izod specimens showed a complete break. The failure modes can be seen in FIGS. 35 and 36. These results show that fiber alignment in the carded MD composite absorbed more shock by resisting the impact, which led to hinged failure. On the other hand, the random fiber orientation in the wet laid composite made it less resistant to impact than carded samples and ultimately caused a complete fracture. The analogy of a bundle of sticks can be used to explain this. For instance, if eight of the ten sticks in the bundle are straight, breaking the bundle becomes challenging. However, if only two or three out of ten sticks are straight, breaking the bundle becomes easy and requires much less effort. Similarly, the majority of fibers in a carded composite are all oriented in the same direction. In that case, the carded composite will be more resistant to impact loading and absorb more impact energy than a wet laid composite, which may only have a few fibers aligned in the same direction.

Differential Scanning calorimetry (DSC) and Thermal Gravimetric Analysis (TGA). The thermal behavior of the rCF-PP composite was characterized by using Q2000 (V24.11 Build 124) DSC instrument. The samples were subjected to heat/cool/heat cycles in the range of 40° C. to 220° C. in the presence of nitrogen gas set at 50 mL/min. First, the samples were heated to 220° C. and kept there for 2 minutes to remove the thermal history. Next, they were cooled to 40° C. at a rate of 10° C./min and then subjected to another heating cycle to 220° C. at a similar rate to attain the melting peak. Due to semi-crystalline nature of PP polymer, the degree of crystallinity (X_{c}) was obtained using the following equation:

$$Xc = ( Δ Hm / Δ Ho ) \times 100 \% ,$$

where ΔHm is the mixing enthalpy of the material (J/g), given by the area under the melting peak;
ΔHo is the melting enthalpy value of a 100% crystalline phase of PP polymer, assumed to be 209 J/g.

TGA was performed on rCF-PP compression molded samples using Q50 (V6.7 Build 203) TGA instrument (TA Instrument, New Castle, Delaware, USA) to understand the thermal characteristics and degradation behavior. The samples weighed approximately 8.00 mg and were heated from room temperature to 600° C. at the rate of 10° C./min under a nitrogen atmosphere. TGA also helped to understand the PP degradation temperature and to determine the fiber weight fraction of rCF in the rCF-PP composite. The DSC and TGA results helped to determine the processing temperatures for fabricating rCF-PP composite panels via compression molding.

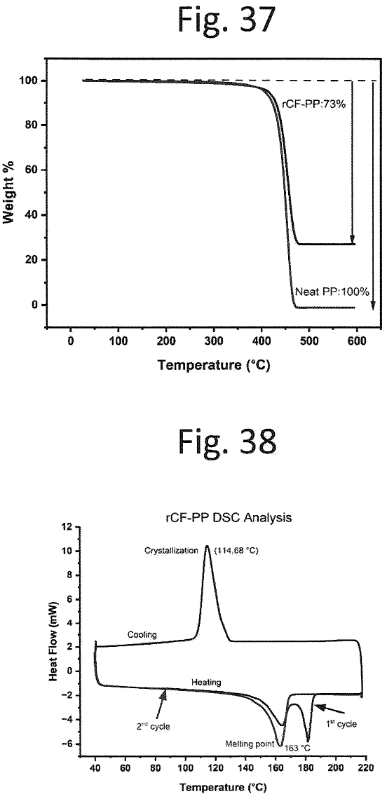

The composite's thermal stability was measured to ascertain the effect of rCF content (30% wt. % fraction) on the thermal degradation of the PP matrix. FIG. 37 illustrates the single-step degradation seen in the TGA analysis for both PP and the rCF-PP composite. After being heated to 300° C., both PP and the rCF-PP composite showed less than 1% weight loss indicating no moisture content, PP stability, and the composite's maximum permissible processing temperature. There was a significant drop in mass between 380° C. and 480° C. because of the thermal degradation of the material. Due to rCF's greater heat absorption capacity than PP, the degradation temperature of all the composites is higher than that of neat PP. At a temperature of 500° C., it was observed that the PP had degraded entirely, whereas the composite still had residual mass. It can be seen that the rCF content in 30 wt. % rCF-PP composite was 27%. The 3% loss of rCF content in the composite can be attributed to the escape of rCF bundles in the carding process.

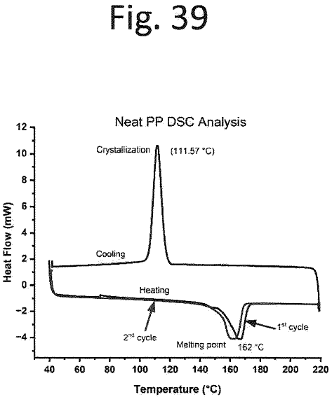

FIGS. 38 and 39 show the DSC results for rCF-PP composite and neat PP, respectively. The melting and crystallization trends were analyzed using the DSC curves. The samples were subjected to heat/cool/heat cycles in the range of 40° C. to 220° C. in the presence of nitrogen gas. Peak melting and peak crystallization temperatures of the rCF-PP composite were determined using DSC analysis. The influence of rCF on those temperatures was verified using DSC analysis of neat PP. The first heat cycle was used to eradicate any traces of thermal history on the PP resin. During the cooling cycle, it was observed that PP begins to recrystallize at 114.7° C. in rCF-PP composite and 111.6° C. in neat PP. After completion of the last heating cycle of the DSC curve, it was observed that the melting point of the rCF-PP composite and neat PP were 163° C. and 162° C., respectively. It was observed that the addition of rCF into PP have no effect on the melting temperature of PP. The equation described previously was used to calculate the degree of crystallinity (X_{c}). The melting enthalpy (ΔHₘ) for rCF-PP (91.22 J/g) and neat PP (114.4 J/g) were obtained from DSC cooling curves. The X_{c} vales for the rCF-PP composite and neat PP were calculated to be 43.6% and 54.7% respectively. It is observed that with the addition of 30 wt. % rCF to PP, the crystallinity of PP decreases. Hence, increasing the weight fraction of rCF reduces the overall crystallization of PP. rCF can act as a suitable nucleating agent because it speeds up the nucleation process and reduce the range of crystallite sizes. DSC and TGA results helped to identify the lower (163° C.) and upper (300° C.) temperature limits for processing parameters in this work.

### CONCLUSIONS

In these Examples, a unique RAM technique with different mixing strategies was used to homogeneously premix the rCF and PP fibers. Carding and wet laying processes were used to manufacture discontinuous rCF reinforced PP nonwoven webs from premix fibers. Two different carding systems were used to evaluate the effect of different carding elements (such as: pin length, cylinder width, combing brush) on nonwoven webs. Both the processes were compared using fiber length distribution, fiber alignment, mechanical characterization, and microscopic analysis. These Examples demonstrate that the carding process manufactures anisotropic (fibers aligned in machine direction) rCF-PP nonwoven preforms whereas the wet laying process manufactures isotropic (randomly oriented) nonwoven preforms. The key findings are as follows:

It was observed that water was the suitable mixing solvent for premixing fibers in RAM process as water is more economical as well as showed uniform/homogeneous mixing as compared to dry and IPA mixing.

The FLD study on rCF fibers from carder 1 showed that lₘ (0.68 mm)<l_{c} (0.89 mm) whereas carder-2 showed that lₘ (1.03 mm)>l_{c} (0.89 mm). The nonwoven mat removal and handling were quite difficult on carder 1 which led to more fiber breakage. Hence, carder 2 was used for further studies.

The flexural strength of the carded MD and carded 0/90 composites were within 5% of one another; however, compared to the wet laid composite, the flexural strength of the carded MD composite was 22% higher. The carded MD and 0/90 composites had flexural moduli were within 10% of each other, but when compared to the wet aid composite, the carded MD composite flexural modulus was 72.2% higher.

The tensile properties showed similar trend as flexural properties. The tensile strength of carded MD and 0/90 composites were within 10% of each other, but when compared to the wet laid composite, the carded MD composite tensile strength was 75% higher. In addition, the tensile modulus of the carded MD composite was much greater than that of carded 0/90 and wet laid composites by 50.8% and 110.8%, respectively. Overall, the carded composite showed significant tensile properties over the wet laid composite, which can be attributed to the fiber alignment achieved during the carding process. The SEM analysis of fractured tensile specimens validates this assumption.

The ILSS results show that the carded MD and 0/90 composite samples were within 7% of each other, whereas the ILSS strength of the carded MD composite was 25% higher when compared with the wet laid composite.

The Izod results showed that the carded MD composite had an impact energy of 46.30 KJ/m² whereas the wet laid composite had an impact energy of 33.7 KJ/m², i.e., the carded MD composite samples could absorb 37.5% more impact energy than the wet laid composite samples. The carded composite's excellent impact energy absorption over the wet laid composite demonstrated the significance of fiber orientation on the impact properties of discontinuous fiber composites.

The tensile properties of the carded MD and wet laid samples' experimental data were compared to discontinuous aligned and discontinuous random theoretical Halpin-Tsai equations, respectively. The results showed that the theoretical modulus of the carded MD composite was 61.93% higher than experimental whereas the theoretical modulus of the wet laid composite was 43.47% higher than experimental.

The embodiments described herein are not limited in their application or use to the details of construction and arrangement of parts and steps illustrated in the drawings and description. Features of the illustrative embodiments and variants may be implemented or incorporated in other embodiments, variants, and modifications, and may be practiced or carried out in various ways. Furthermore, unless otherwise indicated, the terms and expressions employed herein have been chosen for the purpose of describing the illustrative embodiments of the present invention for the convenience of the reader and are not for the purpose of limiting the invention. Having described the invention in detail and by reference to preferred embodiments thereof, it will be apparent that modifications and variations are possible without departing from the scope of the invention which is defined in the appended claims.

What is claimed is:

1. A method of making a carbon fiber-reinforced thermoplastic nonwoven web, comprising the steps of:
providing a quantity of recycled carbon fibers;
providing a quantity of thermoplastic fibers;
mixing the recycled carbon fibers with the thermoplastic fibers using resonant acoustic mixing to provide a nonwoven fiber mixture; and
carding the nonwoven fiber mixture to yield the carbon fiber-reinforced thermoplastic nonwoven web.

2. The method of claim 1, wherein the recycled carbon fibers comprise mechanically recycled carbon fibers.

3. The method of claim 1, where the recycled carbon fibers comprise thermally recycled carbon fibers.

4. The method of claim 1, wherein the recycled carbon fibers comprise chemically recycled carbon fibers.

5. The method of claim 1, wherein the thermoplastic fibers are selected from the group consisting of polypropylene homopolymers and propylene-alpha olefin copolymers containing less than about 10% by weight of an alpha-olefin comonomer.

6. The method of claim 1, wherein the nonwoven fiber mixture comprises about 10% to about 50% by weight of the recycled carbon fibers and about 50% to about 90% by weight of the thermoplastic fibers.

7. The method of claim 1, wherein the nonwoven fiber mixture comprises about 20% to about 40% by weight of the recycled carbon fibers and about 60% to about 80% by weight of the thermoplastic fibers.

8. The method of claim 1, wherein the resonant acoustic mixing occurs for a time period from about 30 seconds to about 10 minutes using a mixing energy of about 25 grams force to about 200 grams force and a frequency of about 40 Hz to about 75 Hz.

9. The method of claim 1, wherein the resonant acoustic mixing is applied to the recycled carbon fibers and the thermoplastic fibers in a dry state.

10. The method of claim 1, wherein the resonant acoustic mixing is applied to the recycled carbon fibers and the thermoplastic fibers dispersed in a liquid.

11. A method of making a carbon fiber-reinforced polypropylene nonwoven web, comprising the steps of:
providing a quantity of recycled carbon fibers;
providing a quantity of polypropylene fibers;
mixing the recycled carbon fibers with the polypropylene fibers using resonant acoustic mixing to provide a nonwoven fiber mixture; and
carding the nonwoven fiber mixture to yield the carbon fiber-reinforced polypropylene nonwoven web.

12. The method of claim 11, wherein the recycled carbon fibers comprise mechanically recycled carbon fibers.

13. The method of claim 11, where the recycled carbon fibers comprise thermally recycled carbon fibers.

14. The method of claim 11, wherein the recycled carbon fibers comprise chemically recycled carbon fibers.

15. The method of claim 11, wherein the polypropylene fibers are selected from the group consisting of polypropylene homopolymers and propylene-alpha olefin copolymers containing less than about 10% by weight of an alpha-olefin comonomer.

16. The method of claim 11, wherein the nonwoven fiber mixture comprises about 10% to about 50% by weight of the recycled carbon fibers and about 50% to about 90% by weight of the polypropylene fibers.

17. The method of claim 11, wherein the nonwoven fiber mixture comprises about 20% to about 40% by weight of the recycled carbon fibers and about 60% to about 80% by weight of the polypropylene fibers.

18. The method of claim 11, wherein the resonant acoustic mixing occurs for a time period from about 1 minute to about 5 minutes using a mixing energy of about 50 grams force to about 150 grams force and a frequency of about 55 Hz to about 65 Hz.

19. The method of claim 11, wherein the resonant acoustic mixing is applied to the recycled carbon fibers and the thermoplastic fibers in a dry state.

20. The method of claim 11, wherein the resonant acoustic mixing is applied to the recycled carbon fibers and the thermoplastic fibers dispersed in a liquid.

21. A method of making a carbon fiber-reinforced thermoplastic nonwoven web, comprising the steps of:
providing about 20% to about 40% by weight of recycled carbon fibers;
providing about 60% to about 80% by weight of thermoplastic fibers;
mixing the recycled carbon fibers with the thermoplastic fibers using resonant acoustic mixing for a time period from about 1 minute to about 5 minutes, about 75 grams force to about 100 grams force, and a frequency of about 55 Hz to about 65 Hz, to provide a nonwoven fiber mixture; and
carding the nonwoven fiber mixture to yield the carbon fiber reinforced thermoplastic nonwoven web.
